(19) United States
(12) Patent Application Publication
(10) Pub. No.: US 2024/0082989 A1
(43) Pub. Date: Mar. 14, 2024

(54) Close Quarters Ratchet And Specialty Fastener Having A Drive Socket In At Least An End Of A Threaded Shaft

(71) Applicant: Patrick J. Santini, West Bend, WI (US)

(72) Inventor: Patrick J. Santini, West Bend, WI (US)

(21) Appl. No.: 17/942,226

(22) Filed: Sep. 12, 2022

(51) Int. Cl. B25B 13/46; B25B 13/48

(52) U.S. Cl. CPC B25B 13/463; B25B 13/481

(57) ABSTRACT

A close quarters ratchet and specialty fastener having a drive socket in a threaded shaft. The close quarters ratchet preferably includes a handle, a ratchet lever, a non-rotation drive unit and a drive socket unit. The handle includes a top handle member and a bottom handle member. The non-rotation drive unit is retained in an end of the top handle member. The drive socket unit is rotatably retained in an end of the bottom handle member. The ratchet lever is pivotally retained between the top and bottom handle members. The non-rotation drive unit preferably includes a spring-loaded drive tool. The drive socket unit preferably includes a drive socket and a gear ring. A rotation projection of the ratchet lever engages the gear ring. Squeezing the handle and the ratchet lever causes the rotation projection to rotate the drive socket unit. A latching unit engages the gear ring.

### BACKGROUND OF THE INVENTION

### 1. Field of the Invention

The present invention relates generally to hand tools and more specifically to a close quarters ratchet and specialty fastener having a socket drive in at least a threaded shaft, which allows a nut to be tightened on the specialty fastener without rotating a ratchet handle.

### 2. Discussion of the Prior Art

Frequently, a nut needs to be tightened on a bolt in a close quarters area. The close quarters area does not have enough room to allow a handle of the ratchet to be swung to tighten the nut on the bolt. China patent no. 102418730 discloses inside and outside hexagon bolts. EPO patent document no. 0926362 discloses a fastener having multiple-drive head and method of manufacture thereof. However, it appears that the prior art does not teach or suggest a bolt with a drive socket located in a threaded shaft. Patent no. 3557644 to Gregory discloses a squeeze action wrench. WIPO patent document no. WO 94/29079 discloses a tool for manually performing rotary movements. However, it appears that the prior art does not teach or suggest a squeeze actuated ratchet, which prevents a threaded shaft of a bolt from rotating while tightening a nut on the threaded shaft.

Accordingly, there is clearly felt need in the art for a close quarters ratchet and specialty fastener having a socket drive in at least an end of a threaded shaft, which allows a nut to be tightened on the specialty fastener without rotating a ratchet handle.

### SUMMARY OF THE INVENTION

The present invention provides a close quarters ratchet and specialty fastener having a socket drive in at least an end of a threaded shaft, which allows a nut to be tightened on the specialty fastener without rotating a ratchet handle. The close quarters ratchet and specialty fastener having a socket drive in each end preferably include a close quarters ratchet and a specialty fastener. The specialty fastener preferably includes a threaded fastener with a first drive socket formed in an end of the threaded shaft. The first drive socket preferably has a hex shape to accommodate a standard size of Allen wrench. However, other shapes of drive sockets could also be used including square, Torx® and any other special shape. A second drive socket may be formed in a head of the specialty fastener. The second drive socket is preferably identical to the first drive socket. The head of the specialty fastener is preferably a standard hex size. However, the head could have a different shape, such as square.

The close quarters ratchet preferably includes a handle, a ratchet lever, a non-rotation drive unit and a drive socket unit. The handle preferably includes a top handle member and a bottom handle member. The top handle member includes a top handle portion and a drive portion, which extends from the top handle portion. The bottom handle member includes a bottom handle portion and a socket portion, which extends from the bottom handle portion. A drive unit hole is formed through the drive portion to receive an outer perimeter of the non-rotation drive unit. The non-rotation drive unit does not rotate relative to the top handle portion. A drive socket hole is formed through the socket portion to rotatably receive the drive socket unit. The ratchet lever is pivotally retained between the top handle member and the bottom handle member. A pivot pin is pressed through an end of the ratchet lever and through the top and bottom handle members to pivotally retain the ratchet lever.

The ratchet lever includes a handle portion and a rotation projection. The rotation projection extends outward from the handle portion, adjacent the pivot pin. A torsion spring biases the ratchet lever outward from a perimeter of the top and bottom handle portions. The non-rotation drive unit preferably includes a drive base, a drive tool, a compression spring and a set-screw retainer. The drive base includes a flange member and a tool retention member, which extends outward from the flange member. The flange member may be pressed into the drive unit hole and/or welded to the drive portion. A spring counterbore is formed in one end of the tool retention member. A set-screw thread is formed in an entrance of the spring counterbore to threadably receive the set-screw retainer. A tool opening is formed through a bottom of the spring counterbore. The drive tool includes a spring flange and a tool portion which extends from a bottom of the spring flange. The tool opening is sized to slidably receive the tool portion. The compression spring is inserted into the spring counterbore. The set-screw retainer is threaded into the set-screw thread to bias the tool portion outward from the drive base.

The drive socket unit preferably includes a drive socket and a gear ring which extends from an outer perimeter of the drive socket at a top of the nut socket. The outer perimeter of the drive socket is sized to rotate in the drive socket hole. A hexagonal socket cavity is formed in a body of the drive socket to receive a hex nut. The gear ring is retained between the drive portion of the top handle member and the socket portion of bottom handle member. The rotation projection of the ratchet lever engages the gear ring. Squeezing the handle and the ratchet lever causes the rotation projection to rotate the drive socket unit. The torsion spring returns the ratchet lever to its original position to allow the drive socket unit to be further rotated to tighten a nut on a threaded fastener.

A latching unit is preferably located on an opposing side of the gear ring. The latching unit preferably includes a pivoting latch, a pivot pin, a compression spring and a spring base. The pivot pin is pressed into a pin hole in the top and/or bottom handle members. The pivoting latch includes a pivot hole for receiving the pivot pin and a spring bore for receiving an end of the compression spring. A bottom of the spring base is attached to the top or bottom handle members. The spring base includes a spring bore for receiving an opposing end of the compression spring. However, other designs of ratcheting mechanisms may also be used. A plurality of spacer pins are preferably used to space the top and bottom handle members apart from each other to provide clearance for the rotation of the gear ring and the pivoting of the ratchet lever, and retain the top and bottom handle members relative to each other. A first close quarters ratchet is used for tightening a hex nut and a second close quarters ratchet is used to loosen a hex nut. The second close quarters ratchet is a mirror image of the first close quarters ratchet. Each size of hex nut requires two close quarters ratchets, which are sized to receive a particular size of hex nut.

These and additional objects, advantages, features and benefits of the present invention will become apparent from the following specification.

### BRIEF DESCRIPTION OF THE DRAWINGS

FIG. 1 is a top perspective view of a specialty fastener for use with a close quarters ratchet in accordance with the present invention.

FIG. 2 is a bottom perspective view of a specialty fastener for use with a close quarters ratchet in accordance with the present invention.

FIG. 3 is a top perspective view of a close quarters ratchet in accordance with the present invention.

FIG. 4 is a bottom perspective view of a close quarters ratchet in accordance with the present invention.

FIG. 5 is an exploded side cross sectional view of a close quarters ratchet with a hex nut threaded on to a specialty fastener, adjacent a drive socket in accordance with the present invention.

FIG. 6 is a side cross sectional view of a close quarters ratchet with a hex nut threaded on to a specialty fastener, the hex nut retained in a drive socket and a drive tool inserted into a hex socket cavity in the specialty fastener in accordance with the present invention.

FIG. 7 is a bottom view of a close quarters ratchet cut through FIG. 6 to illustrate a ratchet mechanism in accordance with the present invention.

FIG. 8 is a cross sectional view of a spacer pin cut through FIG. 6 of a close quarters ratchet in accordance with the present invention.

FIG. 9 is a mirror image of close quarters ratchet shown in FIG. 7 to illustrate a close quarters rachet for loosening a tightened nut in accordance with the present invention.

### DETAILED DESCRIPTION OF THE PREFERRED EMBODIMENTS

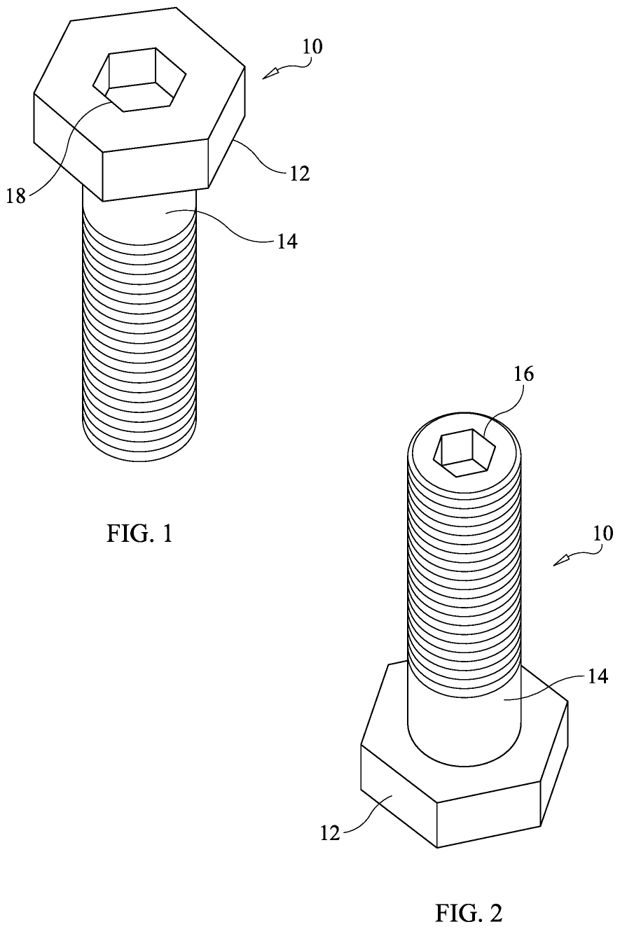

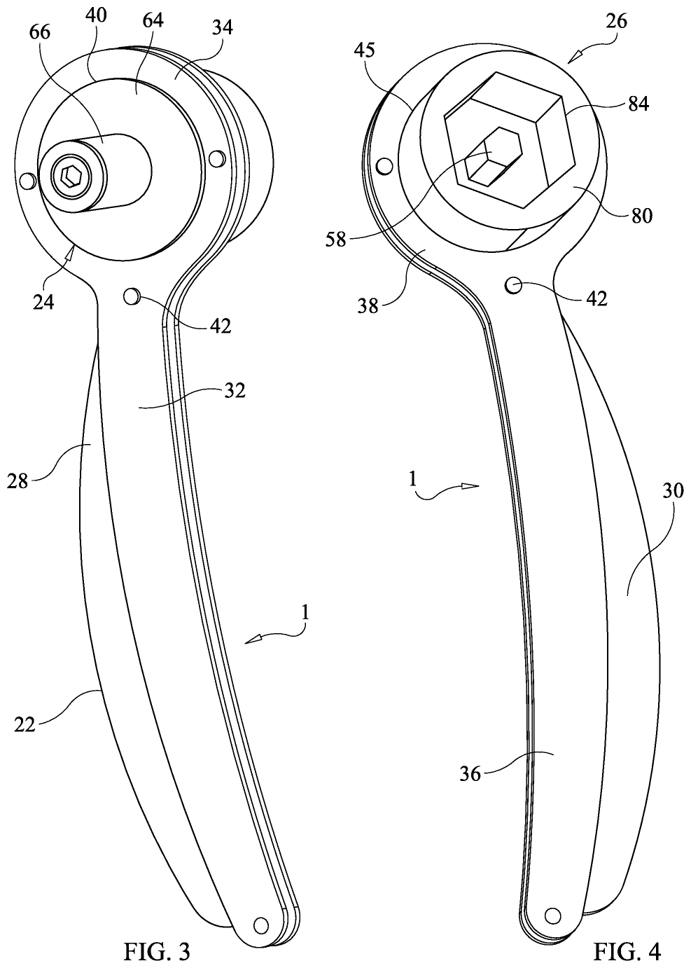

With reference now to the drawings, and particularly to FIG. 4, there is shown a bottom perspective view of a close quarters ratchet 1. With reference to FIGS. 1-2, the specialty fastener 10 preferably includes a hex head 12 and a threaded shaft 14. The threaded shaft 14 extends outward from a bottom of the hex head 12. A first drive socket 16 is formed in an end of the threaded shaft 14. The first drive socket 16 preferably has a hex shape to accommodate a standard size of Allen wrench. However, other shapes of drive sockets could also be used including square, Torx® and any other special shape. A second drive socket 18 may be formed in the hex head 12. The second drive socket 18 is preferably identical to the first drive socket 16. The hex head 12 of the specialty fastener 10 is preferably a standard hex size. However, the hex head 12 could have a different shape, such as square.

With reference to FIGS. 3-4, the close quarters ratchet 1 preferably includes a handle 20, a ratchet lever 22, a non-rotation drive unit 24 and a drive socket unit 26. The handle 20 preferably includes a top handle member 28 and a bottom handle member 30. The top handle member 28 includes a top handle portion 32 and a drive portion 34, which extends from the top handle portion 32. The bottom handle member 30 includes a bottom handle portion 36 and a socket portion 38, which extends from the bottom handle portion 36. A drive unit hole 40 is formed through the top drive portion 34 to receive an outer perimeter of the non-rotation drive unit 24. The non-rotation drive unit 24 does not rotate relative to the top handle portion 32. A drive socket hole 45 is formed through the socket portion 38 to rotatably receive the drive socket unit 26. The ratchet lever 22 is pivotally retained between the top handle member 28 and the bottom handle member 30. A pivot pin 42 is pressed through an end of the ratchet lever 22 and through the top and bottom handle members 28, 30 to pivotally retain the ratchet lever 22.

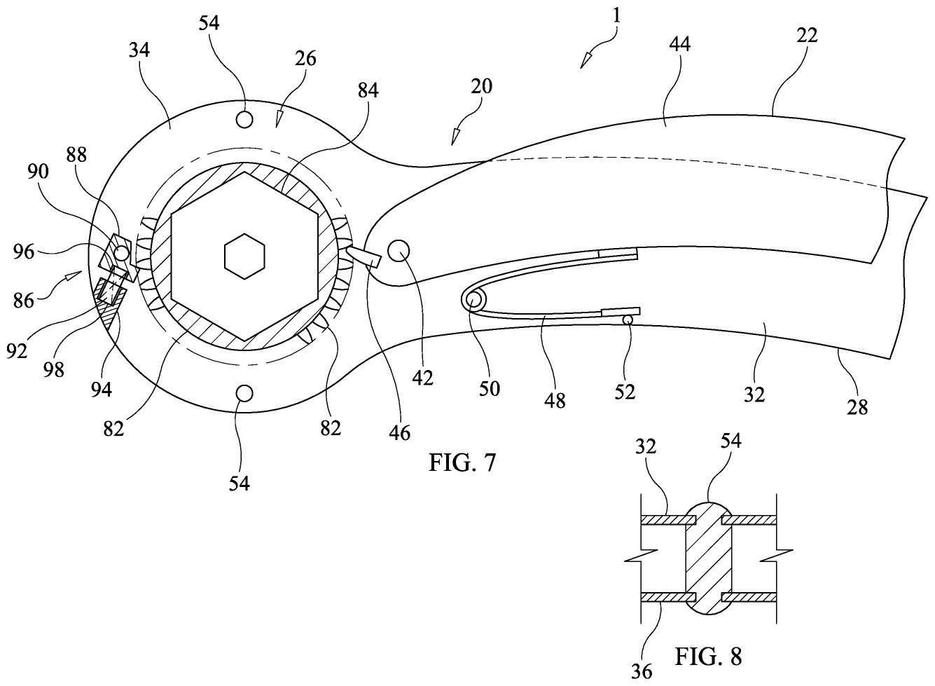

With reference to FIG. 7, the ratchet lever 22 includes a handle portion 44 and a rotation projection 46. The rotation projection 46 extends outward from the handle portion 44, adjacent the pivot pin 42. The rotation projection 46 may be pressed fitted into a cavity in the handle portion 44. However, other attachment methods may also be used, such as welding. A torsion spring 48 biases the ratchet lever 22 outward from a perimeter of the top and bottom handle portions 32, 36. The torsion spring 48 is preferably pivotally retained on a torsion pivot pin 50, which is pressed into at least one of the top and bottom handle portions 32, 36. A support pin 52 is pressed into at least one of the top and bottom handle portions 32, 36 to support an end of the torsion spring 48. With reference to FIG. 8, a plurality of spacer pins 54 are preferably used to space the top and bottom handle members 28, 30 apart from each other to provide clearance for the rotation of a gear ring 82 of the drive socket unit 26 and the pivoting of the ratchet lever 22. Each end of spacer pin 54 may be peened over to retain the top and bottom handle members 28, 30 relative to each other.

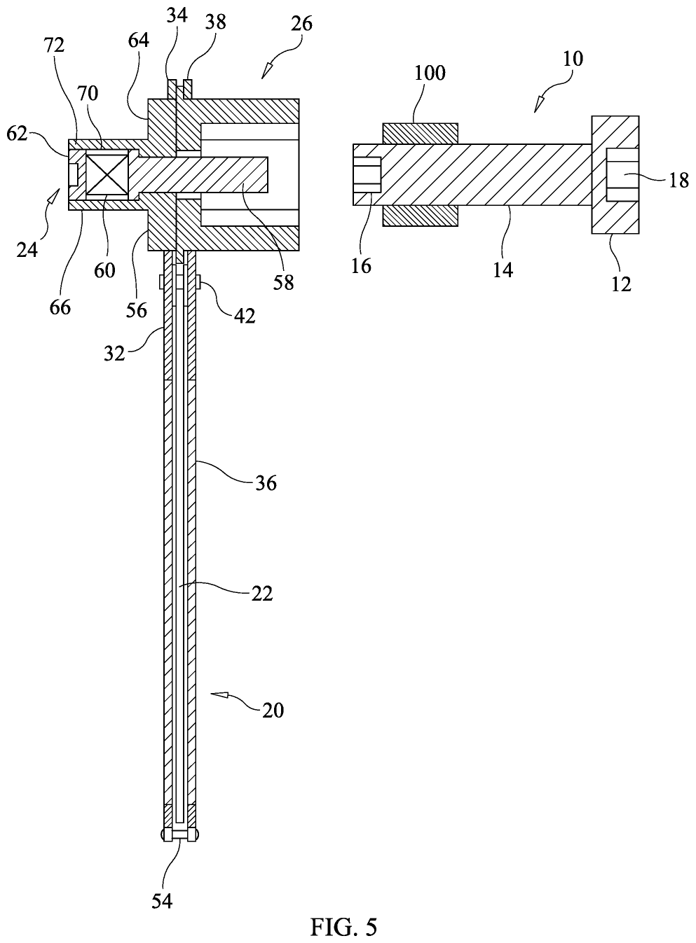

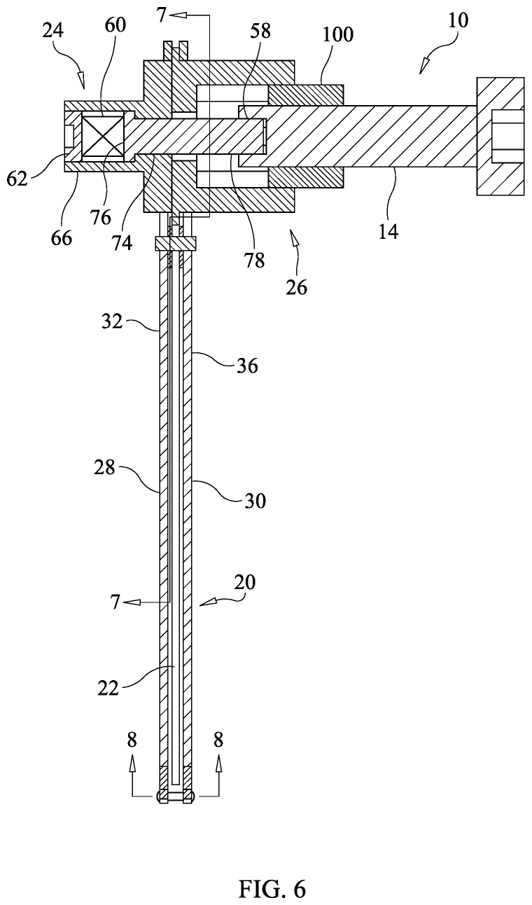

With reference to FIGS. 5-6, the non-rotation drive unit 24 preferably includes a drive base 56, a drive tool 58, a compression spring 60 and a set-screw retainer 62. The drive base 56 includes a flange member 64 and a tool retention member 66, which extends outward from the flange member 64. The flange member 64 may be pressed into the drive unit hole 40 in the drive portion 34 and/or welded to the drive portion 34. A spring counterbore 70 is formed in one end of the tool retention member 66. A set-screw thread 72 is formed in an entrance of the spring counterbore 70 to threadably receive the set-screw retainer 62. A tool opening 74 is formed through a bottom of the spring counterbore 70. The drive tool 58 includes a spring flange 76 and a tool portion 78, which extends from a bottom of the spring flange 76. The tool opening 74 is sized to slidably receive the tool portion. The compression spring 60 is inserted into the spring counterbore 70. The set-screw retainer 62 is threaded into the set-screw thread 72 to bias the tool portion 78 outward from the drive base 56.

With reference to FIG. 7, the drive socket unit 26 preferably includes a drive socket 80 and a gear ring 82 which extends from an outer perimeter of the drive socket 80 at a top of the drive socket 80. The outer perimeter of the drive socket is sized to rotate in the drive socket hole 45. A hexagonal socket cavity 84 is formed in a body of the drive socket 80 to receive a hex nut 100. However, the drive socket 80 could receive a square shaped nut. The gear ring 82 is retained between the drive portion 34 of the top handle member 20 and the socket portion 38 of bottom handle member 30. The rotation projection 46 of the ratchet lever 22 engages the gear ring 82. Squeezing the handle 20 and ratchet lever 22 causes the rotation projection to rotate drive socket unit 26. The torsion spring 48 returns the rachet lever to its original position to allow the drive socket unit 26 to be further rotated to tighten the hex nut 100 on the threaded fastener 10.

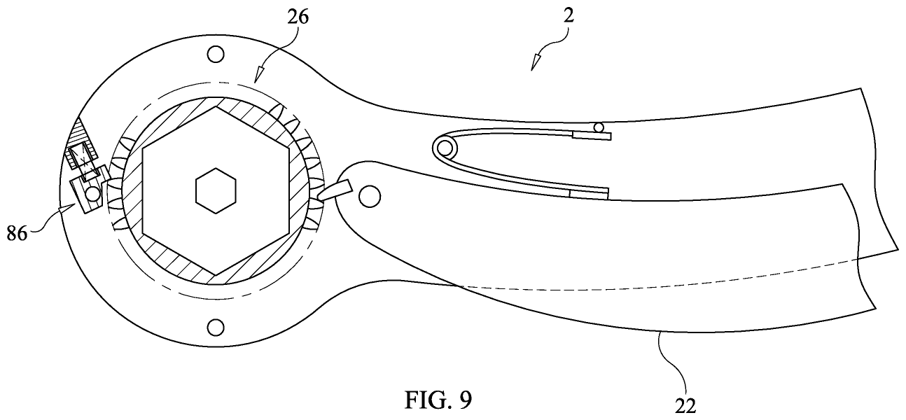

A latching unit 86 is preferably located on an opposing side of the gear ring 82. The latching unit 86 preferably includes a pivoting latch 88, a pivot pin 90, a compression spring 92 and a spring base 94. The pivot pin 90 is pressed into a pin hole in the drive portion 34 or the socket portion 38. The pivoting latch 88 includes a pivot hole for receiving the pivot pin 90 and a spring bore 96 for receiving one end of the compression spring 92. A bottom of the spring base 94 is attached to the drive portion 34 or the socket portion 38. The spring base 94 includes a spring bore 98 receiving an opposing end of the compression spring 92. However, other designs of latching units and ratcheting mechanisms may also be used. With reference to FIG. 9, a first close quarters ratchet 1 is used for tightening the hex nut 100 and a second close quarters ratchet 2 is used to loosen the hex nut 100. The second close quarters ratchet 2 is a mirror image of the first close quarters ratchet 1. Each size of hex nut 100 requires two close quarters ratchets, which are sized to receive a particular size of hex nut.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed:

1. A close quarters ratchet comprising:
a handle includes a top handle member and a bottom handle member;
a ratchet lever is pivotally retained between said top and bottom handle portions;
a drive unit includes a drive tool which is biased outward from said drive unit, a drive hole is formed in one end of said top handle member to receive said drive unit, said drive tool does not rotate relative to said handle; and
a drive socket unit includes a drive socket and a ring gear, said drive socket includes a nut cavity and a tool opening to provide clearance for said drive tool, said ring gear extends from an outside perimeter of said, a socket hole is formed in one end of said bottom handle member to rotatably receive said drive socket unit.

2. The close quarters ratchet of claim 1 wherein:
said ring gear is located on a top of said drive socket.

3. The close quarters ratchet of claim 1, further comprising:
a torsion spring is pivotally retained between said top and bottom handle members, a support pin supports one end of said torsion spring to bias said torsion spring against said ratchet lever.

4. The close quarters ratchet of claim 1 wherein:
said drive socket unit includes said drive tool, a drive base, a compression spring and a set-screw, said drive tool includes a spring flange and a tool portion that extends from a bottom of said spring flange, a spring bore is formed in a top of said drive base, a tool opening is formed through a bottom of said spring bore to provide clearance for said tool portion, said set-screw is threaded into a top of said spring bore to retain said compression spring against said spring flange.

5. The close quarters ratchet of claim 1, further comprising:
a plurality of spacer pins for spacing and retaining said top and bottom handle members relative to each for providing clearance for said ratchet lever and said gear ring.

6. The close quarters ratchet of claim 1, further comprising:
a latching unit including a pivoting latch and a spring, said pivoting latch is pivotally engaged with at least one of said top and bottom handle members, said pivoting latch is biased to engage said gear ring with said spring.

7. A close quarters ratchet comprising:
a handle includes a top handle member and a bottom handle member;
a ratchet lever is pivotally retained between said top and bottom handle portions, said ratchet lever includes a rotation projection;
a drive unit includes a drive tool which is biased outward from said drive unit, a drive hole is formed in one end of said top handle member to receive said drive unit, said drive tool does not rotate relative to said handle;
a drive socket unit includes a drive socket and a ring gear, said drive socket includes a nut cavity and a tool opening to provide clearance for said drive tool, said ring gear extends from an outside perimeter of said, a socket hole is formed in one end of said bottom handle member to rotatably receive said drive socket unit, said rotation projection engages said ring gear; and
a latching unit for preventing reverse rotation of said drive socket relative to said handle, wherein said ratchet lever is actuated to rotate said drive socket.

8. The close quarters ratchet of claim 7 wherein:
said ring gear is located on a top of said drive socket.

9. The close quarters ratchet of claim 7, further comprising:
a torsion spring is pivotally retained between said top and bottom handle members, a support pin supports one end of said torsion spring to bias said torsion spring against said ratchet lever.

10. The close quarters ratchet of claim 7 wherein:
said drive socket unit includes said drive tool, a drive base, a compression spring and a set-screw, said drive tool includes a spring flange and a tool portion that extends from a bottom of said spring flange, a spring bore is formed in a top of said drive base, a tool opening is formed through a bottom of said spring bore to provide clearance for said tool portion, said set-screw is threaded into a top of said spring bore to retain said compression spring against said spring flange.

11. The close quarters ratchet of claim 7, further comprising:
a plurality of spacer pins for spacing and retaining said top and bottom handle members relative to each for providing clearance for said ratchet lever and said gear ring.

12. The close quarters ratchet of claim 7, further comprising:
said latching unit includes a pivoting latch and a spring, said pivoting latch is pivotally engaged with at least one of said top and bottom handle members, said pivoting latch is biased to engage said gear ring with said spring.

13. A close quarters ratchet comprising:
a handle includes a top handle member and a bottom handle member;
a ratchet lever is pivotally retained between said top and bottom handle portions, said ratchet lever includes a rotation projection, said ratchet lever is biased outward from said handle;
a drive unit includes a drive tool which is biased outward from said drive unit, a drive hole is formed in one end of said top handle member to receive said drive unit, said drive tool does not rotate relative to said handle;
a drive socket unit includes a drive socket and a ring gear, said drive socket includes a nut cavity and a tool opening to provide clearance for said drive tool, said ring gear extends from an outside perimeter of said, a socket hole is formed in one end of said bottom handle member to rotatably receive said drive socket unit, said rotation projection engages said ring gear; and
a latching unit for preventing reverse rotation of said drive socket relative to said handle, wherein said ratchet lever is actuated to rotate said drive socket.

14. The close quarters ratchet of claim 13 wherein:
said ring gear is located on a top of said drive socket.

15. The close quarters ratchet of claim 13, further comprising:
a torsion spring is pivotally retained between said top and bottom handle members, a support pin supports one end of said torsion spring to bias said torsion spring against said ratchet lever.

16. The close quarters ratchet of claim 13 wherein:
said drive socket unit includes said drive tool, a drive base, a compression spring and a set-screw, said drive tool includes a spring flange and a tool portion that extends from a bottom of said spring flange, a spring bore is formed in a top of said drive base, a tool opening is formed through a bottom of said spring bore to provide clearance for said tool portion, said set-screw is threaded into a top of said spring bore to retain said compression spring against said spring flange.

17. The close quarters ratchet of claim 13, further comprising:
a plurality of spacer pins for spacing and retaining said top and bottom handle members relative to each for providing clearance for said ratchet lever and said gear ring.

18. The close quarters ratchet of claim 13, further comprising:
said latching unit includes a pivoting latch and a spring, said pivoting latch is pivotally engaged with at least one of said top and bottom handle members, said pivoting latch is biased to engage said gear ring with said spring.
